(19) United States
(12) Patent Application Publication
(10) Pub. No.: US 2003/0172721 A1
(43) Pub. Date: Sep. 18, 2003

(54) Chromotherapy system for a bathtub

(76) Inventors: Henry Brunelle, Cap Rouge (CA); Stephane Baron, Charny (CA)

Correspondence Address: OGILVY RENAULT, 1981 MCGILL COLLEGE AVENUE, SUITE 1600, MONTREAL, QC, H3A2Y3, CA

(21) Appl. No.: 10/173,591

(22) Filed: Jun. 19, 2002

(30) Foreign Application Priority Data
Mar. 15, 2002 (CA) 2,376,932

(51) Int. Cl. G01M 3/00

(52) U.S. Cl. 73/52

(57) ABSTRACT

A system for performing chromotherapy in a bathtub, comprising a light source having light emitting diodes of three different colours for emitting a resultant coloured light output. An intensity of each colour of the light emitting diodes being controllable individually for varying a colour of the resultant coloured light output. The light source is adapted to be mounted to a wall of a bathtub so as to diffuse light in water filling the bathtub. A control module is connected to a power source and to the light source, for controlling the intensity of each of the light emitting diodes to vary a colour of the resultant coloured light output emitted by the light source and diffused in the water of the bathtub.

### TECHNICAL FIELD

The present invention generally relates to chromotherapy and, more particularly, to a system for performing chromotherapy in a bathtub.

### BACKGROUND ART

Light and colour have long been used for treating various diseases and illnesses. Chromotherapy consists in exposing a patient to the different colours or specific colours of the colour spectrum for therapeutic purposes. There are psychological and therapeutic benefits to chromotherapy, and these benefits play an important role in the well-being and the quality of life of a patient, as the human body depends biochemically on light. Every colour is known to have therapeutic and psychological properties. For instance, red is the colour of force, of health and of vitality. Red is also a stimulating colour, and therefore activates blood circulation and has a stimulating effect on the liver. Red is also very energizing and fights against anaemia, as it stimulates the production of hemoglobin. As the red rays of light release heat, they are also excellent for the treatment of the mucous membranes, for de-congestion and for all illnesses aggravated by cold.

### SUMMARY OF INVENTION

It is a feature of the present invention to provide a chromotherapy system adapted for being mounted to bathtubs.

According to the feature of the present invention, from a broad aspect, there is provided a light source for performing chromotherapy in a bathtub, comprising at least three light emitting diodes of different colours for emitting a resultant coloured light output. An intensity of each of the at least three light emitting diodes is controlled individually for varying a colour of the resultant coloured light output. A body has an inner cavity for receiving the at least three light emitting diodes and adapted to be mounted to the wall of the bathtub. The body has an outer wall portion being one of translucent and transparent and positioned such that the resultant coloured light output emitted by the at least three light emitting diodes is diffused by the wall portion into water filling the bathtub.

According to a further feature of the present invention, there is provided a system for performing chromotherapy in a bathtub, comprising a light source having at least three light emitting diodes of different colours for emitting a resultant coloured light output. An intensity of each of the at least three light emitting diodes is controllable individually for varying a colour of the resultant coloured light output. The light source is adapted to be mounted to a wall of a bathtub so as to diffuse light in water filling the bathtub. A control module is connected to a power source and to the light source, for controlling the intensity of each of the light emitting diodes to vary a colour of the resultant coloured light output emitted by the light source and diffused in the water of the bathtub.

According to a still further feature of the present invention, there is provided a method for performing chromotherapy in a bathtub, comprising the steps of providing a light source having at least three light emitting diodes of different colours for emitting a resultant coloured light output, positioning the light source in a bathtub such that the resultant coloured light output of the light source is diffused in water in the bathtub, and controlling an intensity of each of the at least three light emitting diodes individually to vary a colour of the resultant coloured light output diffused in the water in the bathtub.

### BRIEF DESCRIPTION OF DRAWINGS

A preferred embodiment of the present invention will now be described with reference to the accompanying drawings in which:

FIG. 1 is a schematic view of a chromotherapy system constructed in accordance with the present invention, as mounted to a bathtub;

FIG. 2 is an exploded view, partly sectioned, of a light source of the chromotherapy system;

FIG. 3 is a light casing of the light source;

FIG. 4 is an exploded view of a light emitter and a reflector of the light source;

FIG. 5 is a front elevational view of the light emitter; and

FIG. 6 is a schematic view of a configuration of the light emitter.

### DESCRIPTION OF PREFERRED EMBODIMENTS

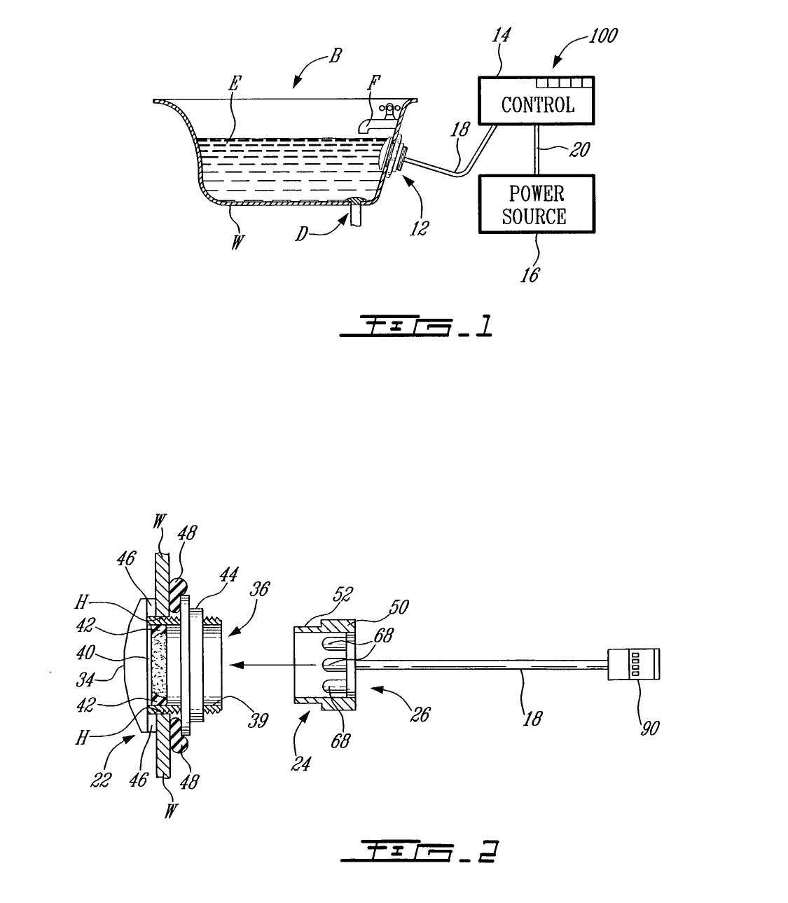

Referring to the drawings and, more particularly to FIG. 1, a chromotherapy system 10 of the present invention has a light source 12, a control module 14 and a power source 16. The light source 12 and the control module 14 are interconnected by a connecting line 18, and the control module 14 and the power source 16 are interconnected by a power line 20. The chromotherapy system 10 is mounted to a bathtub B.

Referring to FIGS. 1 and 2, the bathtub B is a typical bathtub, having a drain D at a bottom thereof and a faucet F for filling the bathtub B with water. The bathtub is illustrated filled with water H. The light source 12 is mounted to the wall W of the bathtub B. The light source 12 is preferably positioned so as to be under water E when a bather is in the bathtub and so as to be visible to a bather.

The light source 12 has a casing 22, a reflector 24 and a light emitter 26. The light emitter 26 is wired to a free end of the connecting line 18.

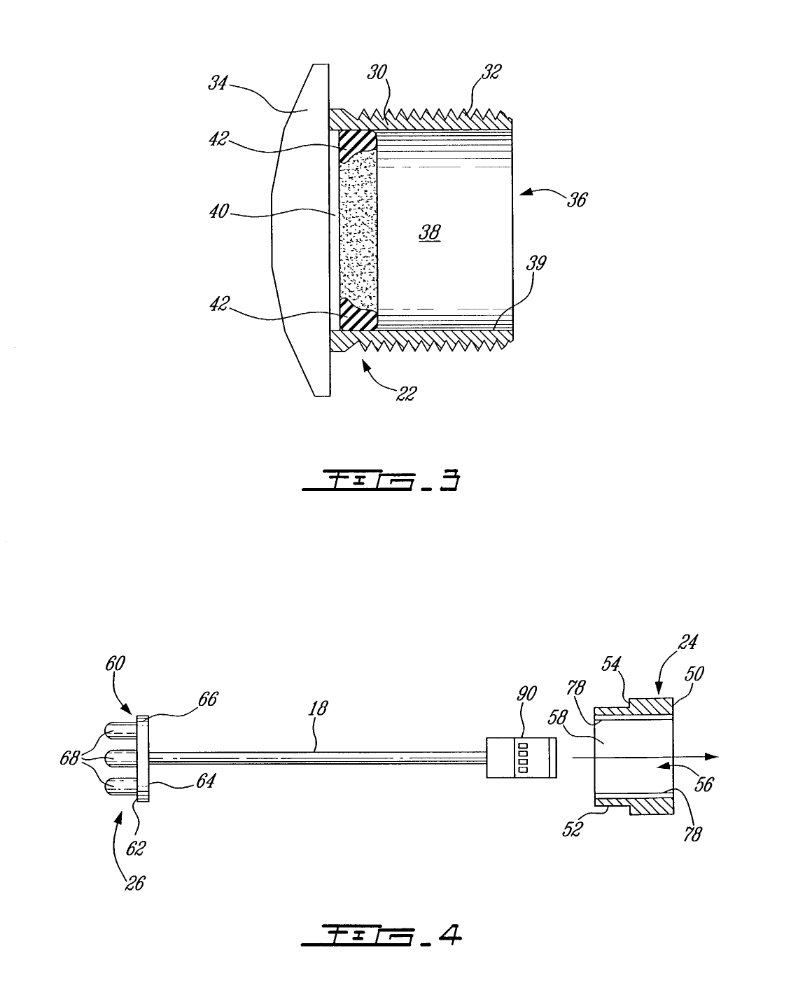

Referring to FIG. 3, the light casing 22 is shown having a cylindrical body 30 with a threaded outer periphery 32. A first end of the cylindrical body 30 has a cap 34 of spherical sections being of transparent or translucent material, such as glass, plastics or the like. The sphere section cap 34 is sealingly secured to the cylindrical body 30. The free end of the cylindrical body 30 has an opening 36 through which an inner cavity 38 of the cylindrical body 30 is accessed. A diffuser 40 is in the inner cavity 38 against an inner surface of the cap 34. A bonding agent, such as sealant 42, secures the diffuser 40 to an inner surface 39 of the inner cavity 38.

As shown in FIG. 2, the light casing 22 also has a nut portion 24 being tapped so as to operatingly engage with the threaded outer periphery 32 of the cylindrical body 30. Accordingly, the light casing 22 is mounted to the wall W of the bathtub B by having the cylindrical body 30 thereof inserted through a hole H in the wall W. Sealing means, such as an annular seal 46, ensures the sealing integrity between a rear surface of the cap 34 of the light casing 22 and an inner surface of the wall W of the bathtub B. Similarly, a silicone joint 48 provides a second level of sealing by being squeezed between an outer surface of the wall W and the nut portion 44 threadingly engaged with the outer periphery 32 of the cylindrical body 30. Although providing the hole H in the bathtub B is a preferred installation of the light source 12, suitable installation configurations may also be used with the chromotherapy system 10 of the present invention.

Referring to FIGS. 2 and 4, the reflector 24 is shown having a cylindrical body 50 with an axially extending end portion 52 of reduced outer diameter. An annular shoulder 54 separates the end portion 52 from the rest of the cylindrical body 50. The cylindrical body 50 has a passageway 56 of generally constant inner diameter. An inner surface 58 of the cylindrical body 50 is reflective. The end portion 52 of the reflector 24 is sized so as to be received in the opening 36 of the casing 22. Although not shown, various methods or devices may be used for securing the reflector 24 to the casing 22. For instance, the end portion 52 may be threaded so as to operatingly engage by tapping in the inner surface 39 defining the inner cavity 38. The annular shoulder 54 limits the insertion of the reflector 24 in the casing 22.

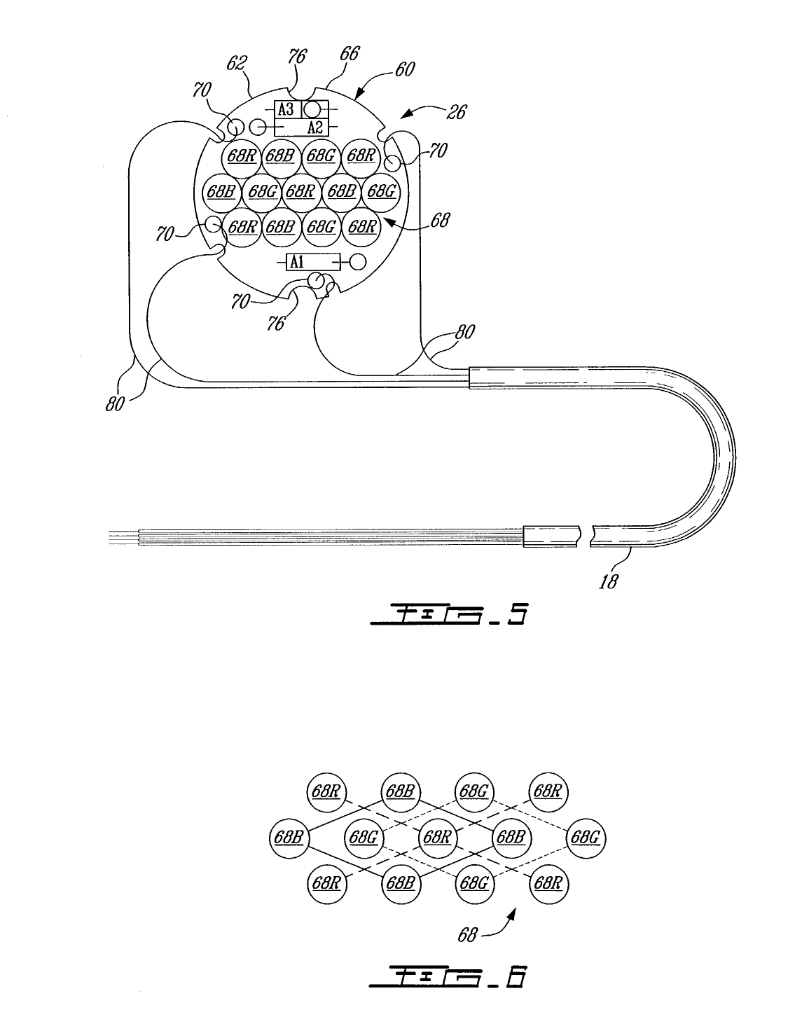

Referring to FIGS. 4 and 5, the light emitter 26 is shown having a circular plate 60 with a front surface 62, a rear surface 64 and a peripheral surface 66 therebetween. The front surface 62 has plural light-emitting diodes 68 thereon (hereinafter LED). More specifically, the light emitter 26 illustrated in FIG. 5 has 13 LED's 68, as will be described hereinafter. Amongst the LED's 68 illustrated in FIG. 5, there are LED's emitting red light and illustrated at 68R, LED's emitting green light and illustrated at 68G, and LED's emitting blue light and illustrated at 68B. The LED's of a same colour are connected serially. Accordingly, three inlet pins 70 are provided, i.e., one pin 70 for each of the lines representing one of the colours of LED's 68. A fourth pin 72 is provided for closing the circuit of the light emitter. The pins 70 and 72 may typically be conductive screws or other similar wire connections. The circular plate 60 preferably comprises a printed circuit board therein in order to circuit the pins 70 to the pin 72 while serially wiring the LED's 68 per colour.

The light emitter 26 of FIG. 5 is shown connected to the four wires 80 of the connecting line 18. As the circular plate 60 is sized for being slidingly received in the passageway 56 of the reflector 24, the circular plate 60 has four notches therein in order to allow for the wires 80 of the connecting line 18 to pass therethrough. The circular plate 60 further comprises slots 76 that coact with guides 78 in the passageway 56 of the reflector, so as to position the circular plate 60 in the reflector 24. The guides 78 may be flared in order to position the circular plate 60 in the reflector 24, with the rear surface 64 of the circular plate 60 flush with a rear end of the reflector 24, as illustrated in FIG. 2. Although the above described installation of the light emitter 26 in the reflector 24 and the light casing 22 is preferred, it is pointed out that other suitable configurations are possible, as long as the light source 12 has the light emitting diodes 68 in position so as to diffuse a light output in the water E filling the bathtub B.

As mentioned previously, the control module 14 is connected to the light source 12 by the connecting line 18. More precisely, the connecting line 18 preferably has a male pin connector 90, with an appropriate number of pins in accordance with the electric requirements of the LED's 68 of the circular plate 60. The control module 14 is equipped with a corresponding female pin connector (not shown). The control module 14 is wired to the power source 16, which is preferably a typical 120 V domestic outlet. The power line 20 may therefore be a typical plug for the domestic outlet.

It is important to note that the control module 14 is programmed to controls the intensity of the red, green and blue LED's 68 to create a resultant light output representing the colours of the colour spectrum. More specifically, the configuration and positioning of the LED's 68 on the circular plate 60 and their varying light intensity emissions and the specific mixing thereof, controlled by the control module 14, enables the emission of the colours of the colour spectrum to expose a bather thereto. The diffuser 40, the reflector 24, and cap 34 and the water E in the bathtub B ensure the appropriate diffusion of the emitted light for efficient chromotherapy sessions. The control module 14 is readily turned on/off by way of an on/off switch actuated by the bather. All or some colours of the light spectrum may be produced by the arrangement and colours of light emitting diodes 68. For instance, the colour indigo is very dark when diffused in the water E of the bathtub B, and therefore the control module 14 of the chromotherapy system 10 may be programmed not to produce indigo coloured light. The control module 14 is preferably provided with control buttons, as shown at 100 in FIG. 1, such that specific colour chromotherapy can be performed.

Referring to FIG. 6, the light emitting diodes 68 of FIG. 5 are shown enlarged to illustrate their configuration. In order for the resultant light beam of the light source 12 to be uniform in colour, it is preferred to have specific patterns of red light emitted diodes 68R, green light emitting diodes 68G and blue light emitting diodes 68B. For instance, in the pattern 110 of FIG. 6, there are no adjacent light emitting diodes 68 of a same colour. By controlling the intensity of these groups we can produce a great number of colours. However, for the therapy of this application, the control module 14 is programmed for producing a plurality of resultant output colours. It is also possible to program several shades of a single colour, such as red which is known to provide excellent therapeutic benefits.

The light source 12 is readily installed and removed from the bathtub B. If some of the diodes 68 need to be replaced, the light emitter 26 can be removed with the reflector 24 from the casing 22. It is preferred that the light emitter 26 be unplugged from the control module 14 prior to being removed from the casing 22. The pin connector configuration of the connecting line 18 and the control module 14 facilitates the replacement of LED's 68 as the light emitter 26 is easily disconnected and reconnected thereafter.

It is within the ambit of the present invention to cover any obvious modifications of the preferred embodiment described herein, provided such modifications fall within the scope of the appended claims.

1. A light source for performing chromotherapy in a bathtub, comprising:
at least three light emitting diodes of different colours for emitting a resultant coloured light output, an intensity of each of the at least three light emitting diodes being controlled individually for varying a colour of the resultant coloured light output; and
a body having an inner cavity for receiving the at least three light emitting diodes and adapted to be mounted to the wall of the bathtub, the body having an outer wall portion being one of translucent and transparent and positioned such that the resultant coloured light output emitted by the at least three light emitting diodes is diffused by the wall portion into water filling the bathtub.

2. The light source according to claim 1, wherein the light source has a group of each of the three light emitting diodes.

3. The light source according to claim 2, wherein the light emitting diodes are positioned with respect to one another such that there are no light emitting diodes of a same colour adjacent to one another.

4. The light source according to claim 1, wherein the different colours of the at least three light emitting diodes are red, blue and green.

5. The light source according to claim 1, wherein the body is sealingly mounted to the bathtub by extending through a hole in a wall of the bathtub.

6. The light source according to claim 1, wherein the at least three light emitting diodes are in a reflective inner cavity of a reflector member received in the inner cavity of the body such that substantially all of the resultant coloured light output is diffused into the water filling the bathtub.

7. The light source according to claim 2, wherein the light source has a printed circuit board and the groups of the at least three light emitting diodes are mounted to the printed circuit board.

8. A system for performing chromotherapy in a bathtub, comprising:
a light source having at least three light emitting diodes of different colours for emitting a resultant coloured light output, an intensity of each of the at least three light emitting diodes being controllable individually for varying a colour of the resultant coloured light output, the light source adapted to be mounted to a wall of a bathtub so as to diffuse light in water filling the bathtub; and
a control module connected to a power source and to the light source, for controlling the intensity of each of the light emitting diodes to vary a colour of the resultant coloured light output emitted by the light source and diffused in the water of the bathtub.

9. The system according to claim 8, wherein the light source has a group of each of the three light emitting diodes.

10. The system according to claim 9, wherein the light emitting diodes are positioned with respect to one another such that there are no light emitting diodes of a same colour adjacent to one another.

11. The system according to claim 8, wherein the different colours of the at least three light emitting diodes are red, blue and green.

12. The system according to claim 8, wherein the light source has a body having an inner cavity for receiving the at least three light emitting diodes and for being mounted to the wall of the bathtub, the body having a wall portion being one of translucent and transparent and positioned such that the light output emitted by the at least three light emitting diodes is diffused by the wall portion into the water filling the bathtub.

13. The system according to claim 12, wherein the body of the light source is sealingly mounted to the bathtub by extending through a hole in a wall of the bathtub.

14. The system according to claim 8, wherein the at least three light emitting diodes of the light source are in a reflective inner cavity of a reflector member received in the inner cavity of the body such that substantially all of the light output is diffused into the water filling the bathtub.

15. The system according to claim 8, wherein the light source has a printed circuit board and plural of the at least three light emitting diodes mounted to the printed circuit board.

16. The system according to claim 8, wherein the at least three light emitting diodes are detachably connected to the control module such that the at least three light emitting diodes can be removed from the body of the light source and detached from the control module to be replaced.

17. The system according to claim 16, wherein a detachable connection between the at least three light emitting diodes and the control module consists of mating pin connectors.

18. A method for performing chromotherapy in a bathtub, comprising the steps of:
providing a light source having at least three light emitting diodes of different colours for emitting a resultant coloured light output;
positioning the light source in a bathtub such that the resultant coloured light output of the light source is diffused in water in the bathtub; and
controlling an intensity of each of the at least three light emitting diodes individually to vary a colour of the resultant coloured light output diffused in the water in the bathtub.

19. The method according to claim 18, wherein the step of providing a light source includes providing groups of the at least three light emitting diodes of different colours.

20. The method according to claim 19, wherein the groups of the at least three light emitting diodes are positioned such that there are no light emitting diodes of a same colour adjacent to one another. 21. The method according to claim 18, wherein the different colours of the light emitting diodes are red, blue and green.
